(19) United States
(12) Patent Application Publication
(10) Pub. No.: US 2007/0281163 A1
(43) Pub. Date: Dec. 6, 2007

(54) CARBONIZED BONDED THERMOSETTING PLASTIC FOAM ASSEMBLIES

(75) Inventors: Thomas M. Matviya, McKees Rocks, PA (US); Rick Lucas, St. Clairsville, OH (US)

Correspondence Address: PHILIP D. LANE, P.O. BOX 79318, CHARLOTTE, NC, 28271-7063, US

(73) Assignee: TOUCHSTONE RESEARCH LABORATORY, LTD., Triadelphia, WV (US)

(21) Appl. No.: 11/421,848

(22) Filed: Jun. 2, 2006

(51) Int. Cl. B32B 9/00

(52) U.S. Cl. 428/408

(57) ABSTRACT

Carbon foam assemblies and a method for the production of such carbon foam assemblies are described where the carbon foam assemblies are characterized in that they are comprised of at least two pieces of carbon foam joined by a carbonaceous region, where carbon of the at least two pieces of carbon foam and carbonaceous region is continuous. A method for producing a carbon foam assembly may comprise bonding at least two pieces of carbonizable polymeric foam together with a carbonizable adhesive to provide a carbonizable polymeric foam assembly, and heating the carbonizable polymeric foam assembly to an elevated temperature to carbonize the carbonizable polymeric foam assembly and provide a carbon foam assembly.

### BRIEF SUMMARY OF THE INVENTION

Carbon foam assemblies and a method for the production of such carbon foam assemblies are described where the carbon foam assemblies are characterized in that they are comprised of at least two pieces of carbon foam joined by a carbonaceous region, where carbon of the at least two pieces of carbon foam and carbonaceous region is continuous. A method for producing a carbon foam assembly may comprise bonding at least two pieces of carbonizable polymeric foam together with a carbonizable adhesive to provide a carbonizable polymeric foam assembly, and heating the carbonizable polymeric foam assembly to an elevated temperature to carbonize the carbonizable polymeric foam assembly and provide a carbon foam assembly.

### BRIEF DESCRIPTION OF THE DRAWINGS

FIG. 1 is an illustration of diagrammatic view of a carbon foam assembly in accordance with an embodiment of the invention.

FIG. 2 is an illustration of an enlarged view of a carbon foam assembly in accordance with an embodiment of the invention.

FIG. 3 is an illustration of a perspective view of a carbon foam assembly in accordance with another embodiment of the invention.

FIG. 4 is an illustration of a perspective view of a carbon foam assembly in accordance with still another embodiment of the invention.

FIG. 5 is an illustration of a perspective view of a carbon foam assembly in accordance with yet another embodiment of the invention.

FIG. 6 an illustration of a perspective view of a carbon foam assembly in accordance with an additional embodiment of the invention.

### DETAILED DESCRIPTION OF EMBODIMENTS OF THE INVENTION

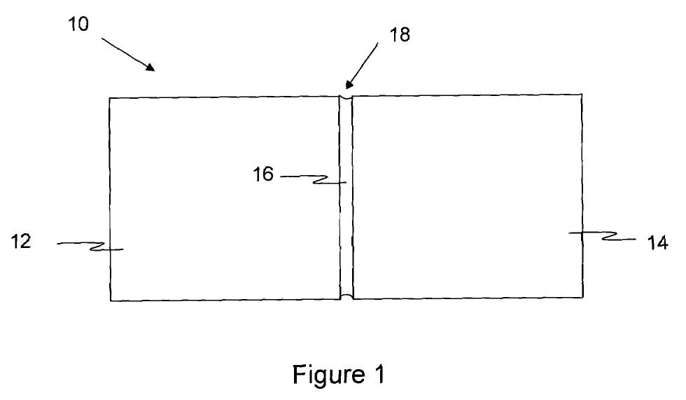

The present invention provides carbon foam assemblies and a method for the production of such carbon foam assemblies. With reference now to FIG. 1, there is illustrated an embodiment of a carbon foam assembly 10. The carbon foam assembly 10 comprises two or more pieces of carbon foam 12 and 14 bonded or joined together by carbonaceous region 16 derived from a carbonizing adhesive, where the carbon of the carbon foam pieces and carbonaceous region is continuous between the carbon foam pieces and the carbonaceous region. While a seam 18 may be visible upon visual inspection, magnification of the carbonaceous region and carbon foam pieces show a structure where the carbon is continuous and integral between the carbon foam pieces and carbonaceous region.

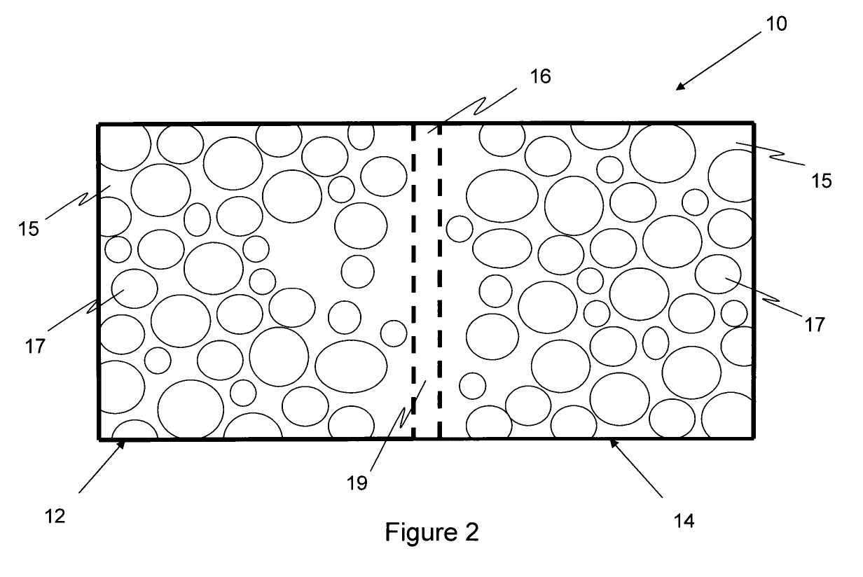

With reference now to FIG. 2, there is shown a magnified illustration of a portion of the carbon foam assembly 10 in accordance with an embodiment of the invention. The carbon foam assembly 10 comprises two or more pieces of carbon foam 12 and 14 bonded or joined together by carbonaceous region 16. The pieces of carbon foam 12 and 14 comprise carbon 15 and void volumes, or cells 17. The two pieces of carbon foam 12 and 14 are bonded together by carbon 19 derived from a carbonizing adhesive in the carbonaceous region 16 between the carbon foam pieces 12 and 14 and extending some distance from the interface into the carbon foam pieces. As shown in this Figure, the carbon derived from the carbonizing adhesive exhibits a continuous carbon structure, that is dense and without substantial grain boundaries, that connects opposing pieces of carbon foam 12 and 14. This connection is also seen to be continuous as it is without boundaries, seams, or other transitions in the carbon material comprising both the foam and the carbon of the carbonaceous region. The carbon comprising both the foam and the carbonaceous region appear to be one piece, that is, structurally continuous, through the bond. In addition to being structurally continuous, the carbon comprising both the foam and the adhesive may also be electrically continuous.

In some embodiments, densification of the carbon foam sections may occur in the carbon foam volumes near the interface of the pieces of carbon foam 12 and 14 with the carbonaceous region 16 which is carbon resulting from the permeation of the carbonizing adhesive into the first few layers of open cells at that interface. This permeation typically occurs when carbonizable polymeric foam sections are initially bonded together to provide a carbonizable polymeric foam enclosure.

The three dimensional shape of the carbon foam assemblies may encompasses elements of any classical geometric shape alone or in any combination, including those in combination with non-classical shapes or irregular surfaces. In some embodiments, the three dimensional shapes of the carbon foam assemblies may include those shapes having interior volumes. The carbon foam assemblies may be used, for example, as enclosures, supports, structural elements, decorations, composite tool bodies, molds, parts of other assemblies, and the like.

The method entails at least intermittently bonding pieces of carbonizable polymeric foam together with a carbonizable adhesive to produce a carbonizable polymeric foam assembly. The polymeric foam assembly is subsequently carbonized to produce the carbon foam assembly. The carbonizable polymeric foam may be a polymeric foam that carbonizes when exposed to sufficiently high temperatures to produce a carbon foam. The carbon foam assembly resulting from such carbonization essentially retains the same shape and cell structure as was exhibited by the polymeric foam assembly prior to carbonization, although some shrinkage, and possibly minor deformation, usually does occur. Suitable carbonizable polymeric foams may be produced from, or comprise, various carbonizable synthetic polymeric materials. Suitable carbonizable synthetic polymeric materials may comprise phenolic or resorcinol resins. Other types of carbonizable synthetic polymeric materials that may be suitable for forming carbonizable polymeric foams may include, but are not limited to, those comprising vinylidene chloride, furfuryl alcohol, furan resins, polyacrylonitrile, acrylonitrile, polyurethane, combinations thereof, and the like. In some embodiments, a suitable carbonizable polymeric foam may include, but is not limited to, those foams commonly referred to as phenolic foams.

The carbonizable adhesive may be any adhesive, thermosetting resin, thermoplastic resin, and/or other material that may bond pieces of carbonizable polymeric foam together and produce a significant quantity of carbon char upon carbonization. The carbon char is the solid decomposition product of the carbonizable adhesive after being carbonized by exposure to elevated temperatures. In some embodiments, the carbonized carbonizable adhesive produces a carbon char that provides the carbonaceous region which is continuous both with itself and with the carbonized polymeric foam. That is, the carbon char providing the carbonaceous region may exhibit a dense carbon structure, without grain boundaries, that connects opposing pieces of carbon foam. In another embodiment, the carbon char in the carbonaceous region may exhibit a foam-like carbon structure. This connection may be also continuous as it may be without boundaries, seams, or other transitions in the carbon material comprising both the foam and the carbonaceous region upon magnified inspection.

Curing or drying of the carbonizable adhesive may be necessary to develop maximum bond strength between the sections of carbonizable polymeric foam. The carbonizable adhesive may be dissolved in or wet with a solvent or other liquid. Generally, carbonizable adhesives that produce higher char quantities (i.e. carbon yields) upon carbonization are preferred. Suitable carbonizable adhesives may comprise, but are not limited to, phenolic resins, resorcinol resins, furan resins, pitch, thermosetting polymers, lignosulfonates, graphite adhesives, and the like. In some embodiments, the carbonizable adhesive may be a thermosetting resin. In other embodiments, the carbonizable adhesive comprises the same type of carbonizable synthetic polymeric material as used to form the carbonizable polymeric foam. By use of the same type of carbonizable synthetic polymeric material as used to form the carbonizable polymeric foam, chemical and thermal compatibility between the carbonizable adhesive and the carbonizable polymeric foam may be insured. That is, use of the same type of carbonizable synthetic polymeric material for both the foam and adhesive may insure that carbonization and the associated material shrinkage, chemical condensation reactions, and physical property changes (strength, electrical conductivity, and thermal conductivity for example) occur not only over the same temperature range but to the same extent with respect to temperature and exposure time. Such considerations may lead to stronger bonds between the resulting bonded pieces of carbon foam comprising the assembly.

The pieces of carbonizable polymeric foam are at least intermittently bonded together using the carbonizable adhesive. That is, the carbonizable adhesive may be applied intermittently along the joining edges or surfaces of the carbonizable polymeric foam pieces to be bonded together. Alternatively, in some embodiments the carbonizable adhesive be applied to all portions of the joining edges or surfaces of the polymeric foam to provide for continuous bonding along all joints. Liberal application of the adhesive may provide for stronger bonds. Partially or fully filling the cells of the foam at the joining edges or surfaces of the carbonizable polymeric foam with the carbonizable adhesive may also provide for stronger bonds.

The size and shape of the carbonizable polymeric foam pieces to be bonded together to form the carbonizable polymeric foam assemblies are not particularly limited. Polymeric foam pieces having a desired shape for incorporation into an assembly may be machined from larger pieces of polymeric foam. Alternatively, polymeric foam pieces having a desired shape for incorporation into an assembly may be foamed from the carbonizable synthetic polymeric material in a suitably shaped mold. Furthermore, pieces of carbonizable polymeric foam may be bonded together by use of a carbonizing adhesive to form a volume of bonded polymeric foam having shapes or dimensions different from those of the desired carbonizable polymeric foam assembly. The resulting bonded carbonizable polymeric foam volume may be shaped by machining, or the like, to provide the desired carbonizable polymeric foam assembly.

Alternatively, the desired carbonizable polymeric foam assembly may have a shape very different from that of the desired carbon foam assembly. Such a carbonizable polymeric foam assembly may be carbonized to provide a carbon foam assembly. This resultant carbon foam assembly may then be shaped to provide a carbon foam assembly of the desired shape and size.

In some embodiments, the polymeric foam assembly may be produced in a size larger than that of the desired carbon foam assembly as shrinkage of the polymeric foam and resultant carbon foam may occur during carbonization. The magnitude of this shrinkage is dependent on treatment temperature(s) and residence time at temperature and the composition of the foam and carbonizing binder. For a given polymeric foam, binder, and temperature exposure program, the magnitude of the shrinkage may be readily determined by routine experimentation. Additionally, as desired, the resultant carbon foam assembly may be machined to final shape and/or dimensions.

The densities of the polymeric foam pieces to be bonded together are also not particularly limited. For example, a piece of higher density carbonizable polymeric foam may be bonded to or in a piece of lower density carbonizable polymeric foam. Such combinations of foams of differing densities may provide, for example, for a stronger localized section(s) of the assembly(s). Such stronger localized sections may then provide, for example, for wall anchor points, localized impact protection, structural support, and the like.

The specific techniques that can be used for joining the carbonizable polymeric foam pieces with carbonizable adhesive may be similar to those that are common to the carpentry arts for the joining of pieces of wood with glue. For example, butt joints, lap joints, dovetail joints, tongue and grove joints, mortise joints, and the like may be used, in combination with the carbonizable adhesive, to join carbonizable polymeric foam pieces together. Such methods may result in strong bonding between the pieces of polymeric foam and the development of appreciable strength and a high degree of continuity in the resulting carbon comprising the bond and the foam. As required or desired, the joints may be held together or reinforced prior to or during heating to carbonization temperatures by the use of clamps and other such retaining devices and techniques.

In some embodiments, the carbonizing adhesive may only penetrate a joining surface of the carbonizable polymeric foam to a relatively shallow depth. As such, for example, lap and butt joints between sections of carbonizable polymeric foam, or the resulting sections of carbon foam, may show good resistance to shear forces but relatively low resistance to tensional forces. Alternatively, other joints such as, for example, tongue and grove joints, mortise joints, and dovetail joints may show good resistance to both shear and tensional forces. Therefore, in some embodiments, joint designs providing good resistance to both shear and tensional forces may be preferred.

Once the polymeric foam pieces are at least intermittently bonded together using the selected carbonizing adhesive, the resulting carbonizable polymeric foam assembly is heated to elevated temperatures, by use of known methods, to progressively carbonize the polymeric foam and adhesive and produce the carbon foam assembly. Heating of the assembly to effect carbonization is typically performed after the carbonizing adhesive has cured or dried, if necessary. Such heating serves to carbonize the carbonizable polymeric foam and carbonizable adhesive to produce a carbon foam assembly. In such an assembly, the carbon of the foam sections comprising the assembly may be continuous with the carbon derived from the carbonizing adhesive.

If the dimensions of the as-produced carbon foam assembly are not within the tolerances desired, the carbon of the assembly may be machined, or otherwise shaped, to the desired dimensions. Machining may be accomplished by the use of conventional methods. Carbide tooling is typically recommended for such machining.

The method of heating of the assembly comprising the carbonizable polymeric foam and adhesive, and the resultant carbon bonded carbon foam assembly to progressively higher temperatures is such that the formation of cracks, warping, and/or breakage of the carbon comprising the resulting carbon foam enclosure does not occur. Such degradation of the carbon comprising the resulting carbon foam assembly may be the result of the development of significant thermal gradients in the assembly. In some embodiments, heating of the assembly may be conducted in a non-reactive, oxygen free, essentially inert atmosphere. Likewise, in some embodiments, cooling of the resultant carbon foam assembly may be conducted in a non-reactive, oxygen free, essentially inert atmosphere until the carbon temperature is minimally less than about 400° C. and more typically less than about 150° C. Such heating may be conducted in conventional industrial-like ovens and furnaces capable of maintaining controlled atmospheres and temperatures.

Heating of the carbonizable polymeric foam assembly or the resultant carbon foam assembly to a maximum desired elevated temperature may be conducted in a continuous manner. Alternatively, such heating may be conducted as a series of steps performed in one or more pieces of heating equipment. For example, the polymeric foam and adhesive assembly may be carbonized in one type of furnace and further carbonized in a second type of furnace, and exposed to graphitization temperatures in a third type of furnace. As an alternative example, the carbonizable polymeric foam assembly may be carbonized, and further heated, even to graphitization temperatures, in a single furnace.

As used in this specification, carbonization of the assembly will be considered to initiate at temperatures greater than room temperature and less than about 700° C. For some carbonizable polymeric foam assemblies, carbonization initiates at a temperature ranging from about 250° C. to about 700° C. In some embodiments, carbonization may be conducted at temperatures greater than about 700° C., even to temperatures as great as about 3200° C. or higher. Graphitization temperatures are a subset of the range of carbonization temperatures and may be considered to extend from about 1700° C., up to about 3200° C. or higher. Generally it is advisable to heat the assembly to greater than about 700° C. Heating the assembly to temperatures greater than about 1000° C. is usually even more advisable as beneficial assembly properties, such as strength and electrical conductivity, may be further increased. As desired, the resultant carbon foam assembly may be heated to temperatures as great as 3200° C. or more.

The carbon foam of the carbon foam assemblies may exhibit a wide range of properties depending upon variables including, but not limited to, the particular carbonizable polymer foam used, the polymer foaming conditions, and the carbonization times and temperatures used to produce the carbon foam article. The carbon foam may exhibit a bulk density ranging from about 0.01 g/cc to about 1 g/cc. In some embodiments, the carbon foam may exhibit a bulk density ranging from about 0.01 g/cc to about 0.8 g/cc. Further, the carbon foam may exhibit compressive strengths ranging from about 50 p.s.i. to about 12,000 p.s.i. In some embodiments, the carbon foam may exhibit compressive strengths ranging from about 150 p.s.i. to about 10,000 p.s.i. Other properties of the carbon foam may include thermal conductivities ranging from about 0.05 W/mK to about 0.4 W/mK.

The carbon foam assemblies may include those assemblies comprising two or more sections of carbon foam, produced from carbonized polymeric foam, bonded, or otherwise connected, together by carbon char derived from a carbonizing adhesive which provides the carbonaceous region. The carbon derived from the carbonizing adhesive in the carbonaceous region is structurally continuous with that of the carbon foam. As the carbon resulting from the carbonizing adhesive, originally bonding the polymeric foam sections together, is continuous with the carbon of the foam pieces, thermal and electrical conductivity across the bond may be improved relative to conventional bonding methods and/or carbon foam assemblies.

The carbon foam assembly may be fully or partially surfaced coated, covered, or faced with other materials using conventional methods. These other materials may extend from the assembly. Such other materials may provide, for example, additional assembly strength, waterproofing, bracing, impact resistance, and the like. Such other materials may comprise, but are not limited to, carbon foam, fiberglass, thermosetting and thermoplastic polymers, paint, ceramics, polymeric composites, carbon composites, wood, paper, metals, metal composites, and the like. As desired or required, such other materials may be applied, for example, by dipping, spraying (including thermal spraying), hand lay-up methods, painting, gluing, mechanical fasteners, deposition (including chemical vapor deposition and vacuum deposition), and the like. The carbon foam assemblies may also be completely or partially impregnated with thermosetting or thermoplastic polymers, resins, ceramics, metal, carbon, and the like. Such impregnation may provide for additional assembly strength, bracing, waterproofing, impact resistance, and the like. Interior or exterior supports may be affixed to the assembly. Such supports may be comprised of any solid material having sufficient strength to provide additional support to the assembly. Such solid materials may include, but are not limited to, wood, solid polymers, composites, metals, and carbon foam. Additionally, the carbon foam assemblies of the present invention may be incorporated into other assemblies, articles, devices, and the like.

The use of carbon foam in the assemblies of the present invention provides these assemblies with beneficial properties which may make such assemblies particularly suitable in applications requiring the strength, thermal stability, or chemical inertness inherent to carbon materials. Such applications may include, but are not limited to: structural supports, thermal shielding enclosures, electromagnetic interference (EMI) shielding enclosures, impact shielding enclosures, blast shielding enclosures, and assemblies having an inner or outer surface suitable for use in composite tooling.

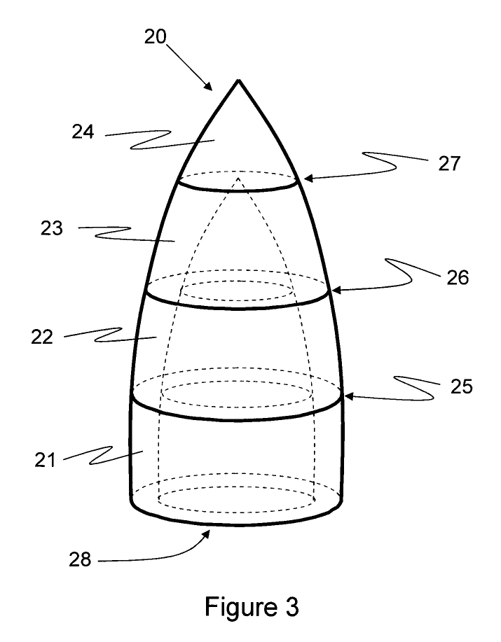

Turning now to FIG. 3, there is illustrated another embodiment of a carbon foam assembly 20. In this illustration, the carbon foam assembly 20 is comprised of four pieces of carbon foam. One of these carbon foam pieces 21 has a shape resembling a hollow cylinder. Two other pieces of the carbon foam 22 and 23 resemble hollow frustrums. The fourth piece of carbon foam 24 resembles a cone. These four pieces of carbon foam are arranged in the assembly as illustrated. The carbon foam pieces are joined to neighboring pieces of carbon foam at their mutually contacting surfaces, also referred to as joining lines or joining surfaces, 25, 26, and 27 by carbon comprising a carbonaceous region derived from a carbonizing binder. The carbon derived from the carbonizing binder comprising the carbonaceous region may be continuous with that carbon of the foam. A portion 28 of the interior volume of the assembly is hollow.

Such an assembly may be prepared by a number of methods all of which are encompassed in the present invention. For example, sections of carbonizable polymeric foam may be machined to provide pieces of polymeric foam having shapes similar to but larger than those of the carbon foam pieces of the carbon foam assembly. Such shaped sections of carbonizable polymeric foam may then be bonded with a carbonizing adhesive to provide a carbonizable polymeric foam assembly of the desired configuration. As another example, pieces of polymeric foam may be cast, molded, or otherwise produced in shapes similar to but larger than those of the carbon foam pieces of the carbon foam assembly. Such shaped sections of carbonizable polymeric foam may then be bonded with a carbonizing adhesive to provide a carbonizable polymeric foam assembly of the desired configuration.

The carbonizable polymeric foam assembly of the desired configuration is then heated, as previously described, to an elevated temperature sufficient to carbonize the foam and adhesive and result in a carbon foam assembly. Following heating, the resultant carbon foam assembly may be cooled. Heating of the polymeric foam assembly or the resultant carbon foam assembly may be conducted in a non-reactive, oxygen free, essentially inert atmosphere. Likewise, cooling of the foam assembly may be conducted in a non-reactive, oxygen free, essentially inert atmosphere until the carbon foam temperature is minimally less than about 400° C. and more preferably less than about 150° C.

Other methods, also encompassed in the present invention, by which such a carbon foam assembly may be produced do not require the forming of individual polymeric foam pieces to shapes approximating those of the carbon foam pieces in the assembly. For an assembly such as that illustrated by FIG. 3, four sections of carbonizable polymeric foam panels may be bonded together using a carbonizable adhesive to provide an initial polymeric foam assembly having an internal volume capable of encompassing the polymeric foam assembly that is the precursor to the carbon foam assembly. This assembly of flat sheets may be then machined or otherwise shaped to provide a carbonizable polymeric foam assembly of the desired configuration. This carbonizable polymeric foam assembly may then be carbonized as previously described. Alternatively, such an assembly of flat carbonizable polymeric foam sheets may constitute a carbonizable polymeric foam assembly of the desired configuration. Such a carbonizable polymeric foam assembly may be carbonized as discussed above. The resulting carbonized polymeric foam assembly may then be machined or otherwise shaped to provide a carbon foam assembly of the desired size and configuration.

The resulting carbon foam assembly may be shaped to the desired final dimensions and subsequently surfaced coated, covered, faced, and/or impregnated with other materials as discussed previously.

A carbon foam assembly such as that illustrated in FIG. 3 may have many utilities. For example, such a assembly may be incorporated in a rocket nose cone. In such an application the carbon foam assembly may be carbonized at high temperatures to accentuate the strength and thermal and electrical conductivity of the carbon foam assembly. Alternatively, for example, such an assembly may comprise an artillery shell impact or thermal shield. The specific requirements of such an application would determine the most favorable carbon foam assembly maximum carbonization temperature.

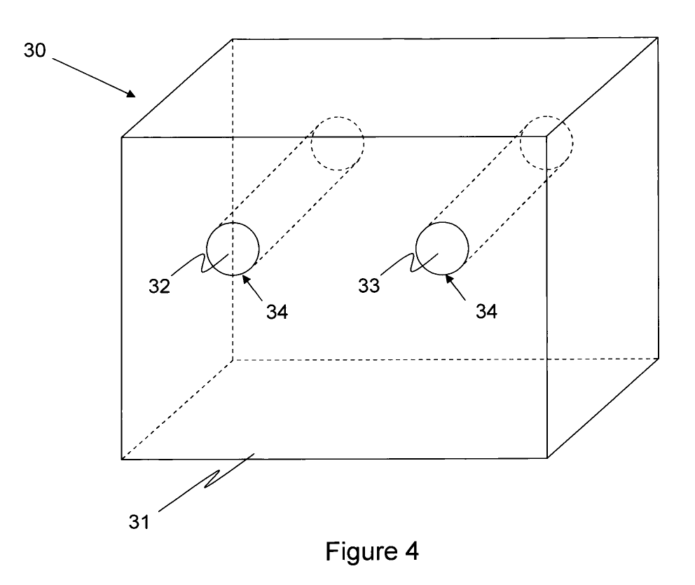

With reference now to FIG. 4, there is illustrated another embodiment of a carbon foam assembly 30. In this embodiment, the carbon foam assembly 30 is comprised of three pieces of carbon foam. One of the pieces of carbon foam 31 is a rectangular piece of carbon foam of a predetermined density. This rectangular piece of carbon foam defines one or more through holes. A carbon foam cylinder 32 and 33, also having a density, is secured in each of these holes by carbon of a carbonaceous region that was derived from a carbonizing binder located at their joining surfaces 34. The carbon of the carbonaceous region may be continuous with the carbon comprising both the rectangular piece of carbon foam and that comprising the carbon foam cylinders.

Such a carbon foam assembly may be prepared, for example, by carbonizing, as previously described, a carbonizable polymeric foam assembly of similar construction, shape, and of a slightly larger size. A larger size is advisable to compensate for the shrinkage of the assembly that may occur as a result of carbonization. Such a polymeric foam assembly is comprised of three pieces of carbonizable polymeric foam bonded together in the arrangement shown using a carbonizable adhesive. The densities of the polymeric foam pieces may be equivalent or different. Any differences in densities between the polymeric foam pieces will be evident in the resulting carbon foam assembly. Such differences can provide specific utilities to the carbon foam assembly. For example, if the densities of the cylindrical polymeric foam pieces are greater than that of the rectangular polymeric piece, the resulting carbon foam assembly will have localized volumes of higher density carbon foam positioned in the assembly as were the polymeric foam cylinders. The higher density carbon foam would be expected to be stronger and more thermally and electrically conductive than is the lower density carbon foam. Such localized sections of higher density carbon foam may then provide for improved localized heat or electrical transport through the carbon foam assembly. Such higher density carbon foam sections may also increase the strength of the carbon foam assembly. Additionally, such higher density/higher strength carbon foam may provide areas of higher strength in the assembly suitable for use with mechanical fasteners. Such mechanical fasteners may then be used for attachment of the carbon foam assembly to other materials or assemblies.

Alternatively, the densities of the cylindrical polymeric foam pieces may be less than that of the rectangular polymeric piece resulting in a carbon foam assembly having localized volumes of lower density carbon foam positioned in the assembly as were the polymeric foam cylinders. As carbon foam density decreases, the resistance to fluid flow through the carbon foam generally decreases. Therefore the inclusion of lower density carbon foam volumes in the carbon foam assembly may provide improved localized fluid transfer through the carbon foam assembly.

As was discussed in the first illustration, the resulting carbon foam assembly may be surfaced coated, covered, or faced with other materials as discussed previously. Also, the carbon foam may be impregnated as has also been previously discussed.

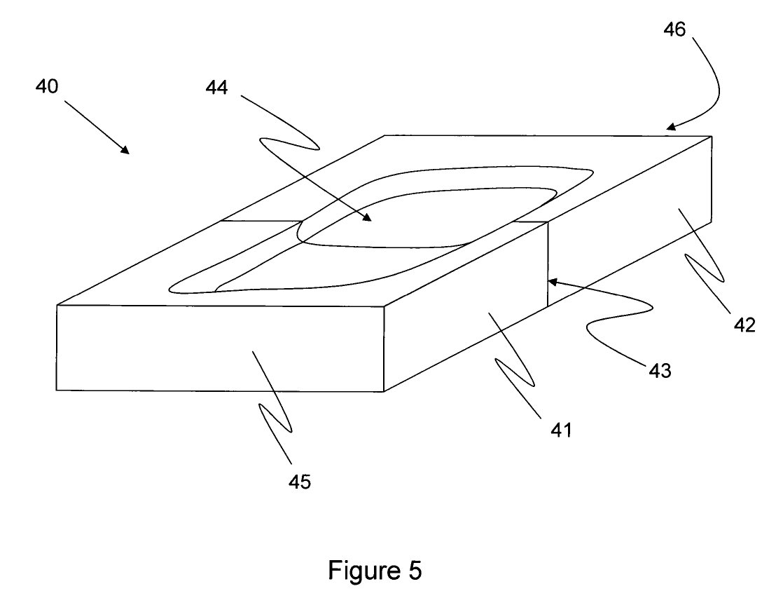

Turning now to FIG. 5, there is shown another embodiment of a carbon foam assembly 40. The carbon foam assembly 40 is comprised of two pieces of carbon foam 41 and 42 bonded together at their joining surfaces 43 by a carbonaceous region derived from a carbonizing binder. The carbon foam assembly has a depression 44 on its top surface. Such a carbon foam assembly may be prepared from pieces of carbonizable polymeric foam boned together at their joining surfaces using a carbonizable binder. The resulting carbonizable polymeric foam assembly may be carbonized, as described above, to provide a carbon foam assembly. The carbon derived from the carbonizable binder is preferably continuous with the carbon of the carbon foam. The depression in the top surface of the carbon foam assembly may be machined in the carbon foam after carbonization. Optionally, the depression may be machined in the carbonizable polymeric foam assembly prior to carbonization. And as another option, the carbonizable polymeric foam pieces may be machined or cast in a suitable mold, prior to bonding to form the assembly, to provide for the top surface depression.

As was discussed previously, provision may be made for any shrinkage that may be exhibited by the carbonizable polymeric foam assembly with conversion to the carbon foam assembly. Also, the resulting carbon foam assembly may be surfaced coated, covered, or faced with other materials and/or the carbon foam may be impregnated as has been previously discussed.

The carbon foam assembly of FIG. 5 may comprise a portion of a tool body for the forming of composite materials. In this example, the depressed top surface of the carbon foam assembly could be used as a tool face or support other materials that comprise a tool face for the forming of composite materials into composite parts. Carbonization of the carbon foam assembly at a suitably high temperature may result in a carbon foam assembly having appreciable electrical conductivity. Therefore attaching suitable electrodes to opposite faces 45 and 46 of the assembly may provide for the passage of an electric current through a carbon foam assembly carbonized at a suitable temperature. As the carbon derived from the carbonizing adhesive is preferably continuous with the carbon of the carbon foam pieces, a significant potential drop is not encountered at the joining line between the carbon foam pieces. The passage of electric current through the carbon foam assembly can lead to resistive heating of the assembly. This resistive heating may in turn heat the composite materials on the tool face which may reduced curing times and result in more rapid composite part production.

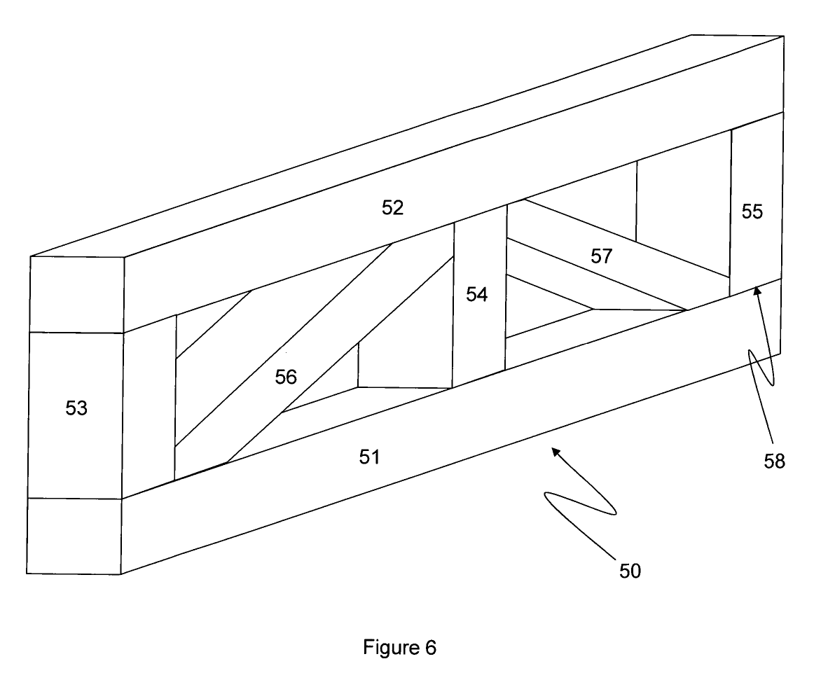

Another embodiment of a carbon foam assembly is illustrated in FIG. 6. The carbon foam assembly 50 is comprised of a plurality of carbon foam pieces 51, 52, 53, 54, 55, 56, and 57 bonded together at their joining surfaces, one such surface being designated the reference numeral 58, by carbon char derived from a carbonizing binder in the carbonaceous region to form a strut-like assembly. Such a carbon foam assembly may be prepared from pieces of carbonizable polymeric foam bonded together using a carbonizable binder. The resulting carbonizable polymeric assembly may be carbonized, as described above, to provide a carbon foam assembly. The carbon of the carbonaceous region derived from the carbonizable binder is continuous with the carbon of the carbon foam. For applications where such an assembly would be utilized for load-bearing purposes, the strength of the assembly may be increased by carbonizing the assembly at a maximum temperature of about 1000° C. or greater.

As was discussed previously, provision may be made for any shrinkage that may be exhibited by the carbonizable polymeric foam assembly with conversion to the carbon foam assembly. Also, the resulting carbon foam assembly may be surfaced coated, covered, or faced with other materials and/or the carbon foam may be impregnated as has also been previously discussed. Such surface coating or impregnation may significantly increase the strength of the carbon foam assembly. As was also discussed previously, the carbon foam assembly may be machined to desired dimensions.

The strut-like assembly illustrated in FIG. 6 may be used, for example, either alone or incorporated in other assemblies for load-bearing purposes. The tolerance of carbon foams to high temperatures, especially under inert atmospheres, makes such assemblies especially useful in high temperature applications. Carbon foams are also relatively chemically unreactive. Therefore such assemblies may have utilities in harsh environments.

While several embodiment of the invention have been described in detail, the described embodiments are only several of many embodiments of the invention. The invention is only limited by the following claims.

What is claimed is:

1. A carbon foam assembly comprising:
at least two pieces of carbon foam joined by a carbonaceous region, wherein carbon of the at least two pieces of carbon foam and carbonaceous region is structurally continuous.

2. The carbon foam assembly of claim 1 wherein the carbon foam assembly defines at least one depression.

3. The carbon foam assembly of claim 1 wherein at least one piece of carbon foam of said at least two pieces of carbon foam defines a hole and at least one other piece of carbon foam of said at least two pieces of carbon foam is sized to be received in the hole.

4. The carbon foam assembly of claim 1, wherein the carbon foam assembly defines an internal void volume.

5. The carbon foam assembly of claim 1, wherein the carbon foam has a density ranging from about 0.05 g/cc to about 1 g/cc.

6. The carbon foam assembly of claim 1, wherein the carbon foam has a density ranging from about 0.05 g/cc to about 0.8 g/cc.

7. The carbon foam assembly of claim 1, wherein the carbon foam has a compressive strength ranging from about 50 p.s.i. to about 12,000 p.s.i.

8. The carbon foam assembly of claim 1, wherein the carbon foam has a compressive strength ranging from about 150 p.s.i. to about 10,000 p.s.i.

9. A method for preparing a carbon foam assembly comprising the steps of:
bonding at least two pieces of carbonizable polymeric foam together with a carbonizable adhesive to provide a carbonizable polymeric foam assembly; and
carbonizing said carbonizable polymeric foam assembly to provide a carbon foam assembly.

10. The method of claim 9 wherein, the step of carbonizing further comprises heating said carbonizable polymeric foam assembly to an elevated temperature.

11. The method of claim 9, wherein said carbonizing is conducted in a non-reactive, oxygen free, essentially inert atmosphere.

12. The method of claim 10, further comprising the step of cooling said carbon foam assembly from said elevated temperature in a non-reactive, oxygen free, essentially inert atmosphere.

13. The method of claim 9, further comprising the step of shaping at least one of said at least two pieces of carbonizable polymeric foam.

14. The method of claim 9, further comprising the step of shaping said carbonizable polymeric foam assembly.

15. The method of claim 9, further comprising the step of shaping said carbon foam assembly.

16. The method of claim 9, wherein said carbonizable polymeric foam comprises phenolic foam.

17. The method of claim 9, wherein said carbonizable polymeric foam is produced from phenolic resin.

18. The method of claim 9, wherein said carbonizable polymeric foam is produced from resorcinol resin.

19. The method of claim 9, wherein said carbonizable polymeric foam is produced from a carbonizable polymeric material selected from the group consisting of vinylidene chloride, furfuryl alcohol, furan resin, polyacrylonitrile, acrylonitrile, and polyurethane.

20. The method of claim 9, wherein said carbonizable adhesive comprises phenolic resin.

21. The method of claim 9, wherein said carbonizable adhesive comprises resorcinol resin.

22. The method of claim 9, wherein said carbonizable adhesive is selected from the group consisting of resorcinol resin, furan resin, pitch, thermosetting polymers, lignosulfonates, and graphite adhesives.

23. The method of claim 9, wherein said elevated temperature is a temperature greater than about 700° C.

24. The method of claim 23, wherein said elevated temperature is a temperature greater than about 1000° C.

25. The method of claim 9, wherein said bonding is continuous.

26. The method of claim 9, wherein said bonding is intermittent.
